(19) United States
(12) Patent Application Publication
(10) Pub. No.: US 2014/0025333 A1
(43) Pub. Date: Jan. 23, 2014

(54) POSITION MEASUREMENT APPARATUS, POSITION MEASUREMENT METHOD, AND NON-TRANSITORY COMPUTER READABLE MEDIUM

(71) Applicant: RENESAS MICRO SYSTEMS CO., LTD., Kanagawa (JP)

(72) Inventor: Mayumi HAYAKAWA, Kanagawa (JP)

(73) Assignee: RENESAS MICRO SYSTEMS CO., LTD., Kanagawa (JP)

(21) Appl. No.: 13/946,717

(22) Filed: Jul. 19, 2013

(30) Foreign Application Priority Data
Jul. 20, 2012 (JP) 2012-161758

(51) Int. Cl. G01B 7/00

(52) U.S. Cl. CPC G01B 7/003
USPC 702/150

(57) ABSTRACT

A position measurement apparatus includes a reference value acquisition unit that obtains a plurality of reference geomagnetism information pieces, the plurality of reference geomagnetism information pieces being geomagnetism information pieces measured at a plurality of reference positions, an association information generation unit that generates association information that associates the plurality of reference positions with the plurality of reference geomagnetism information pieces, a measurement value acquisition unit that obtains measurement geomagnetism information, the measurement geomagnetism information being geomagnetism information measured at a measurement position and a position specifying unit that specifies a position corresponding to the measurement geomagnetism information based on association between the plurality of reference positions and the plurality of reference geomagnetism information pieces obtained by the association information.

### CROSS-REFERENCE TO RELATED APPLICATIONS

This application is based upon and claims the benefit of priority from Japanese patent application No. 2012-161758, filed on Jul. 20, 2012, the disclosure of which is incorporated herein in its entirety by reference.

### BACKGROUND

The present invention relates to a position measurement apparatus, a position measurement method, and a non-transitory computer readable medium. For example, the present invention can be suitably used for a position measurement apparatus, a position measurement method, and a non-transitory computer readable medium, measuring a position based on the geomagnetism (terrestrial magnetism).

In recent years, as 3D (three-dimensional) games/3D television sets have come into widespread use, new human interfaces aimed at the markets of 3D games/3D television sets have been getting attention. To make the “tactile force sense” or the like, which is one of the new human interfaces, implementable, it has been desired to develop a technique capable of reliably measuring positions and movement amounts of humans, objects, and the like.

As related-art measurement techniques, acceleration sensors, optical sensors, ultrasonic sensors, image recognition, GPSs, geomagnetic sensors, and the like have been known. For example, Japanese Unexamined Patent Application Publication No. 2009-156779 discloses a measurement apparatus using a geomagnetic sensor.

FIG. 18 shows a related-art measurement operation disclosed in Japanese Unexamined Patent Application Publication No. 2009-156779. As shown in FIG. 18, in the related art, firstly, a successive movement counter and a direction change counter are initialized (step A1). Next, a geomagnetic component Hg is detected in a sampling cycle by using a triaxial geomagnetic sensor (step S2), and the information of the geomagnetic component Hg detected by the triaxial geomagnetic sensor is stored (accumulated) as geomagnetic component information A (step A3).

Next, two temporally-consecutive geomagnetic component information pieces A are obtained from a plurality of stored geomagnetic component information pieces A, and a difference vector Hv between the two obtained geomagnetic component information pieces A and its absolute value Ha are calculated as a difference Hd (step A4).

Then, it is determined whether the apparatus is moving or at a standstill based on the calculated absolute value Ha (step A5). When it is determined that the apparatus is moving (see the “moving state” route in the step A5), direction information a and sign information b are stored as difference information D. On the other hand, when it is determined that the apparatus is at a standstill (see the “standstill state” route in the step A5), the process returns to the step A1.

Next, in the “moving state” route, the moving state is determined based on a result of comparison between the previously-calculated difference information and the currently-calculated difference information (step A6). The successive movement counter or the direction change counter is incremented based on the comparison result of the difference information. Further, when the successive movement counter or the direction change counter is greater than a threshold value, it is determined that the apparatus is “moving” or is “swung”.

Then, the “moving” (step A8) or the “swung” (step A9) is output according to the determination result, and the process is finished. In the related art, it is determined whether an apparatus is being swung or is moving by repeatedly performing the process from the steps A1 to A9 or the like.

Note that Published Japanese Translation of PCT International Publication for Patent Application, No. 2001-500299 discloses an input device that measures a local magnetic field and/or the geomagnetic field (geomagnetism).

### SUMMARY

Japanese Unexamined Patent Application Publication No. 2009-156779, which discloses the related art as described above, obtains geomagnetic component information and calculates a difference between the previously-calculated geomagnetic component information and the currently-calculated geomagnetic component information. When the object whose movement is to be detected is moving, the geomagnetic component information at the current measurement place is changed from the previously-measured geomagnetic component information. Therefore, a difference is generated therebetween. It is such a technique that when this difference increases to or above a threshold value, it is determined that the object has moved.

However, in a measurement apparatus using the related-art geomagnetic sensor, the measurement is carried out based on difference information of the geomagnetism. Therefore, although it is possible to detect whether the object is moving or not, it is impossible to measure the position of the object. In particular, the geomagnetism fluctuates according to the measurement place, the time, the environment, and the like. Therefore, there is a problem that it is very difficult to measure the position based on the geomagnetism in the related art like the one disclosed in Japanese Unexamined Patent Application Publication No. 2009-156779.

Other problems to be solved and novel features will be apparent from the following descriptions of this specification and the attached drawings.

A one aspect is a position measurement apparatus including a reference value acquisition unit, an association information generation unit, a measurement value acquisition unit, and a position specifying unit. The reference value acquisition unit obtains a plurality of reference geomagnetism information pieces, the plurality of reference geomagnetism information pieces being geomagnetism information pieces measured at a plurality of reference positions. The association information generation unit generates association information that associates the plurality of reference positions with the plurality of reference geomagnetism information pieces. The measurement value acquisition unit obtains measurement geomagnetism information, the measurement geomagnetism information being geomagnetism information measured at a measurement position. The position specifying unit specifies a position corresponding to the measurement geomagnetism information based on association between the plurality of reference positions and the plurality of reference geomagnetism information pieces obtained by the association information.

According to the one aspect, it is possible to provide a position measurement apparatus, a position measurement method, and a non-transitory computer readable medium, capable of measuring a position by using the geomagnetism.

### BRIEF DESCRIPTION OF THE DRAWINGS

The above and other aspects, advantages and features will be more apparent from the following description of certain embodiments taken in conjunction with the accompanying drawings, in which:

FIG. 1 is a configuration diagram for explaining an outline of a position measurement apparatus according to an embodiment;

FIG. 2 is a configuration diagram showing a configuration of a TV game system according to a first embodiment;

FIG. 3 is a block diagram showing a configuration of functional blocks of a remote controller according to a first embodiment;

FIG. 4 is a flowchart showing an operation of a remote controller according to a first embodiment;

FIG. 5 is a diagram for explaining a geomagnetism measurement operation of a remote controller according to a first embodiment;

FIG. 6 is a diagram for explaining a geomagnetism measurement operation of a remote controller according to a first embodiment;

FIG. 7 is a diagram showing a measurement example of geomagnetism measurement values of a remote controller according to a first embodiment;

FIG. 8 is a diagram showing a measurement example of geomagnetism measurement values of a remote controller according to a first embodiment;

FIG. 9 is a block diagram showing a configuration of functional blocks of a remote controller according to a second embodiment;

FIG. 10 is a flowchart showing an operation of a remote controller according to a second embodiment;

FIG. 11 is a diagram for explaining a geomagnetism measurement operation of a remote controller according to a second embodiment;

FIG. 12 is a diagram showing a measurement example of geomagnetism measurement values of a remote controller according to a second embodiment;

FIG. 13 is a diagram showing a measurement example of geomagnetism measurement values of a remote controller according to a second embodiment;

FIG. 14 is a diagram showing a measurement example of geomagnetism measurement values of a remote controller according to a second embodiment;

FIG. 15 is a block diagram showing a configuration of functional blocks of a remote controller according to a third embodiment;

FIG. 16 is a flowchart showing an operation of a remote controller according to a third embodiment;

FIG. 17 is a diagram showing a measurement example of geomagnetism measurement values of a remote controller according to a third embodiment; and

FIG. 18 is a flowchart showing an operation in related art.

### DETAILED DESCRIPTION

### Overview of Embodiments

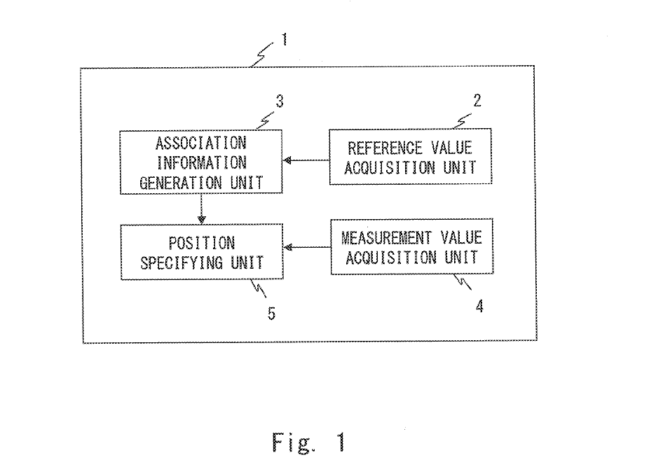

Firstly, the overview of an embodiment is explained with reference to FIG. 1. As shown in FIG. 1, a position measurement apparatus 1 according to an embodiment includes a reference value acquisition unit 2, an association information generation unit 3, a measurement value acquisition unit 4, and a position specifying unit 5. The reference value acquisition unit 2 obtains a plurality of reference geomagnetism information pieces that are geomagnetism information pieces measured at a plurality of reference positions. The association information generation unit 3 generates association information that associates the plurality of reference positions with the plurality of reference geomagnetism information pieces. The measurement value acquisition unit 4 obtains measurement geomagnetism information that is geomagnetism information measured at a measurement position. The position specifying unit 5 specifies a position corresponding to the measurement geomagnetism information based on association between the plurality of reference positions and the plurality of reference geomagnetism information pieces obtained by the association information. For example, the association information corresponds to a reference value table, a curved-line expression, an approximate expression, or the like (which are described later).

With the configuration like this, it is possible to measure a position by using the geomagnetism in order to specify a measurement position based on the association between a plurality of reference positions and a plurality of reference geomagnetism information pieces, and measurement geomagnetism information. Further, it is possible to calculate a movement amount based on this measured position, and thus making it possible to reliably measure the movement amount.

As one of the new human interfaces aimed at the markets of 3D games/3D television sets, a “tactile force sense” providing technique has been known as described above. As one of the techniques constituting this “tactile force sense” providing technique, there is a “technique for measuring a movement amount of a human or an object”. For example, in order to give a sense of touching a 3D image to a viewer in a 3D television set, there is a tactile force sense providing system that provides an artificial touching sensation. When a tactile force sense is to be provided to a hand of a user by using this system, the movement amount of that hand (i.e., the movement amount from the position before the movement to the position after the movement) is measured in order to determine the relative position of the hand with respect to the 3D image, to determine how much the hand has moved, to determine whether the hand is in contact with the 3D image or not, and so on.

That is, such a tactile force sense providing system provides a sense of touch and/or a sense of force to the body of a user according to the position and the movement amount of an object to be measured such as a hand based on a result obtained by measuring its position and movement amount. Therefore, it is necessary to reliably measure the position and the movement amount of the object to be measured.

As related-art techniques for measuring a movement amount of an object, measurement techniques using an acceleration sensor, an optical sensor, an ultrasonic sensor, image recognition, and/or a GPS have been known.

That is, an acceleration sensor is often used for measurement of a movement amount of a human or an object. For example, an acceleration sensor is installed in a remote controller of a home-use TV game machine, and game play control and/or character movement control are performed according to the movement amount of the remote controller. The use of an acceleration sensor makes it possible to measure a movement amount based on an acceleration that is detected according to the movement, and the movement time. However, there is a problem that when the speed of the movement is too low to detect the acceleration, the movement is not detected, thus making the measurement of the movement amount impossible. Further, the acceleration sensor cannot detect the position.

Meanwhile, there is a system using an optical sensor in other movement amount measurement techniques. This system requires a light source in addition to the optical sensor, and detects the movement and measures the movement amount by capturing light from the light source. However, there is a problem that when a shielding object is present between the optical sensor and the light source, the light sensor cannot detect the movement of an object to be measured, thus making the measurement of the position and the movement amount impossible.

Further, in the case of a system using an ultrasonic sensor, an ultrasonic transmitter and an ultrasonic receiver are used. An ultrasonic wave emitted from the transmitter is reflected on an object whose movement amount is to be measure, and the distance is measured based on the time required for the ultrasonic wave to returns the receiver. A difference occurs in measurement results (e.g., a difference between the previous measurement result and the latest measurement result), thus making it possible to detect the movement and measure the movement amount. However, there is a problem that, because of the surrounding environment, an error could occur in the measurement result of the position and/or the movement amount, and/or the measurement could not be carried out. This is because there are cases in which the ultrasonic wave is not reflected, thus making the measurement impossible, cases in which another reflective object is present between the reflective object and the transmitter/receiver, and thus causing an incorrect result, and so on.

Further, in the case of a system in which a camera is used and movement detection and movement measurement of an object is carried out by performing image processing, there is a problem that the image of the object cannot be captured due to the presence of a shielding object between the camera and the object to be measured and/or the lack of lighting or insufficient illumination of the surrounding environment, thus making the detection of the position and movement and the measurement of the movement amount impossible.

Further, in the case of a system using a GPS, there are cases in which the measurement of the position and/or the movement amount cannot be performed because the system is disposed indoors and the communication with the satellite is thereby disconnected. Further, when the system is used for movement amount measurement performed within the movement range of a person, there is another problem that the measurement accuracy is poor.

Therefore, an embodiment makes it possible to measure a position and a movement amount by using the geomagnetism. By using the geomagnetism, it is possible to reliably measure a position and a movement amount even when a shielding object is present.

Further, as shown in FIG. 18, the related art using a geomagnetic sensor can detect only whether the object is moving or not, but cannot measure the position and the movement amount. Accordingly, as shown in FIG. 1, an embodiment makes it possible to measure a position and a movement amount by using the geomagnetism by obtaining a plurality of reference positions and a plurality of reference geomagnetism information pieces and associating the reference positions with the reference geomagnetism information pieces in advance.

### First Embodiment

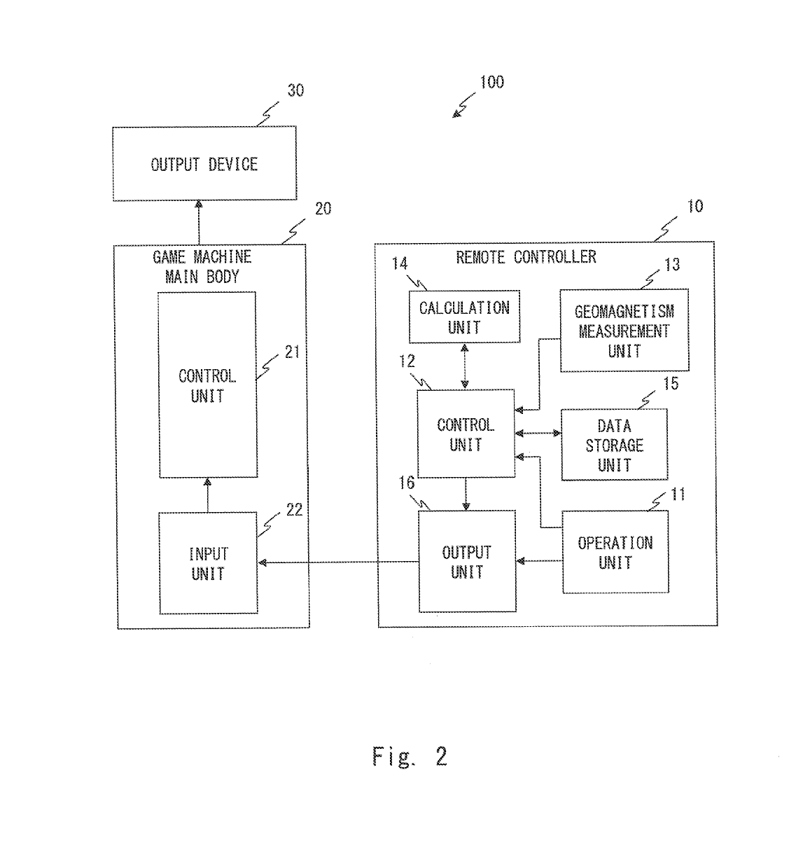

A first embodiment is explained hereinafter with reference to the drawings. FIG. 2 shows a configuration example of a system using a movement amount measurement technique using the geomagnetism according to this embodiment, in which a position measurement function and a movement amount measurement function are incorporated into a TV game machine.

As shown in FIG. 2, a TV game system (video game system) 100 according to this embodiment includes an operation unit (hereinafter referred to as “remote controller”) 10 with which a user operates the game system, a game machine main body 20 that receives a control signal(s) output from the remote controller 10 and controls the game system, and an output device 30 that performs image display and the like of the game system under the control of the game machine main body 20.

Note that although the remote controller 10, the game machine main body 20, and the output device 30 are shown as separate units in the TV game system 100, the number of units (housings) included in the TV game system 100 can be arbitrarily determined. For example, each of the remote controller, the game machine main body, and the output device may be formed as an individual unit. Alternatively, the game machine main body and the output device may be formed as one combined unit. Further, the remote controller, the game machine main body, and the output device may be formed as one combined unit.

However, in this embodiment, the remote controller 10 measures the geomagnetism. Therefore, in the cases where the game machine main body 20 and/or the output device 30 affect the geomagnetism measured by the remote controller 10, the remote controller 10 is preferably operated in a place far away from the game machine main body 20 and/or the output device 30.

The remote controller 10 includes: an operation unit 11 that instructs to measure a movement amount, to transmit a measurement result, and so on; a control unit 12 that manages and controls internal functions of the remote controller; a geomagnetism measurement unit 13 that measures a geomagnetic component(s); a calculation unit 14 that calculates a geomagnetic force, position information, a movement amount based on the geomagnetic component information obtained from the geomagnetism measurement unit 13, and generates a control signal(s) according to their result; a data storage unit 15 that stores the geomagnetic component information, the position information, and the movement amount calculation result; and an output unit 16 that output the control signal(s) to the game machine main body 20. Each unit of the remote controller 10 is formed by a semiconductor device. For example, the control unit 12 and the calculation unit 14 may be formed by one semiconductor device (i.e., one semiconductor chip).

For example, the operation unit 11 is a button(s) or the like of the remote controller. When a user presses a button while moving the remote controller 10 held by his/her hand, movement amount measurement starts. Further, the operation unit 11 also instructs the control unit 12 of the execution timing of an operation such as outputting a measured movement amount to the game machine main body 20.

For example, the control unit 12 is a CPU of a micro computer installed in the remote controller, and controls various functions according to the functions of the remote controller. The control unit 12 obtains a geomagnetic component measurement result (geomagnetic component information) from the geomagnetism measurement unit 13 at regular intervals based on time measurement performed by the control unit 12, or under the instruction of the operation unit 11. The control unit 12 passes this result to the calculation unit 14, and obtains the calculation result, i.e., geomagnetic component information, position information, and the movement amount measurement result. The control unit 12 passes this result to the output unit 16, and provides an output instruction to the output unit 16 under the instruction of the operation unit 11, or at regular intervals based on time measurement performed by the control unit 12. Further, the control unit 12 exchanges data such as a geomagnetic force and a movement amount with the data storage unit 15.

The geomagnetism measurement unit 13 is a geomagnetic sensor that measures (detects) multiple-axis geomagnetic components. In the case where the geomagnetism measurement unit 13 is a triaxial geomagnetic sensor, for example, the geomagnetism measurement unit 13 outputs geomagnetic component information obtained by measuring geomagnetic components along the X, Y and Z axes to the control unit 12 as a measurement result. Further, when the geomagnetism measurement unit 13 is a biaxial geomagnetic sensor, the geomagnetism measurement unit 13 outputs geomagnetic component information obtained by measuring geomagnetic components along the X and Y axes to the control unit 12 as a measurement result. The measurement of geomagnetic components by the geomagnetism measurement unit 13 is performed at regular intervals (in a sampling cycle) based on time measurement performed inside the sensor.

The calculation unit 14 obtains the geomagnetic component information along the X, Y and Z axes (or along the X and Y axes) measured by the geomagnetism measurement unit 13 from the control unit 12, and calculates a geomagnetic force based on the geomagnetic component information. Further, the calculation unit 14 calculates a position and a movement amount based on the geomagnetic force.

The data storage unit 15 is a memory that stores programs and various data necessary for the operations of control unit 12 and other units. For example, the data storage unit 15 stores geomagnetic component information measured by the geomagnetism measurement unit 13, position calculation results (position measurement results) and movement amount calculation results (movement amount measurement results) processed by the control unit 12 and the calculation unit 14, and the like.

The output unit 16 outputs a control signal(s) such as a position measurement result and a movement amount measurement result obtained from the control unit 12 to the game machine main body 20. For example, the output unit 16 is connected with an input unit 22 of the game machine main body 20 through a wire or wirelessly so that the output unit 16 can communicate with the game machine main body 20, and receives/outputs a control signal(s).

The game machine main body 20 includes an input unit 22 that receives a control signal(s) from the remote controller 10, and a control unit 21 that controls the game system according to the control signal. The input unit 22 obtains a control signal(s) such as a movement amount measurement result from the remote controller 10.

The control unit 21 is a CPU or the like. The control unit 21 controls a character(s) of a video game and a tactile force sense based on the position and the movement amount obtained by the input unit 22, and outputs an output signal(s) to the output device 30 according to the control. The control unit 21 executes an application program of a video game, and implements functions of the game according to the program. The control unit 21 generates a control signal(s) for controlling a visual effect to be displayed to a user and/or a tactile force sense to be provided to the user according to the position and the movement amount measured by the remote controller 10.

The output device 30 is a display, a speaker, and/or the like, and is connected with the game machine main body 20. Further, the output device 30 displays images and/or outputs sounds. Further, when the game performed in the game machine main body 20 is a 3D video game, the output device 30 includes a 3D television set and/or a tactile force sense providing device. Further, the output device 30 displays a 3D image and/or provides a tactile force sense according to the position and the movement amount measured by the remote controller 10. The output device 30 displays a 3D image on the 3D television set and provides a tactile force sense to a hand of a user by using the tactile force sense providing device. For example, when a user moves the remote controller 10 and thereby touches an object on a 3D image, the game machine main body detects that the user touches the 3D image according to the moved position and the movement amount of the remote controller 10, and the tactile force sense providing device provides an object touching sensation to the hand of the user.

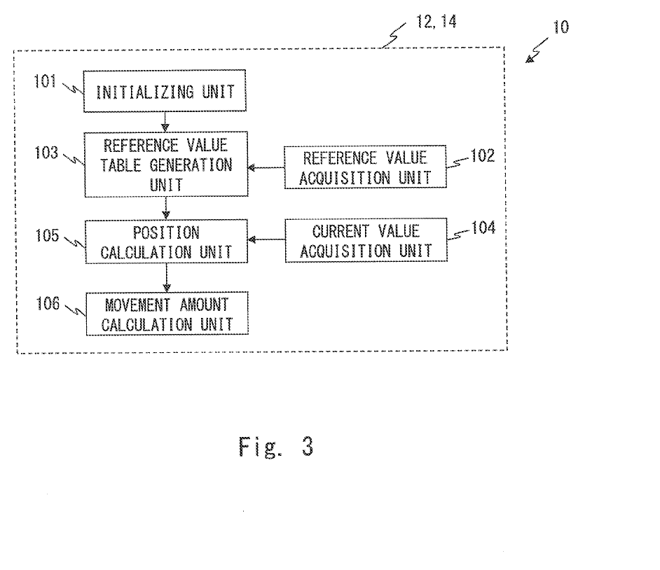

FIG. 3 is a functional block diagram of the remote controller 10 according to this embodiment, and shows a configuration example of blocks for performing mainly movement amount measurement (position measurement) in the control unit 12 and the calculation unit 14. Note that the functional block diagram shown in FIG. 3 is a mere example. That is, other block configurations may be also used, provided that the movement amount measurement operation (position measurement operation) according to this embodiment can be implemented. Further, each block (each function, each processing unit) in FIG. 3 may be formed by hardware, software, or combination thereof. For example, each block in the control unit 12 and the calculation unit 14 may be implemented by causing a computer (CPU) to execute a control program(s) for the movement amount measurement operation (position measurement operation) according to this embodiment.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

As shown in FIG. 3, the remote controller 10 according to this embodiment includes, as functions of the control unit 12 and the calculation unit 14, an initializing unit 101, a reference value acquisition unit 102, a reference value table generation unit 103, a current value acquisition unit 104, a position calculation unit 105, and a movement amount calculation unit 106. Note that the calculation unit 14 performs mainly arithmetic processing (calculation processing) among these processes. However, the control unit 12 or the calculation unit 14 may perform any of these processes.

The initializing unit 101 initializes the control unit 12 and each unit of the remote controller 10 when the remote controller 10 is powered up.

The reference value acquisition unit 102 obtains geomagnetic component information that is used as pre-measured reference values from the geomagnetism measurement unit 13 in advance of the movement amount measurement (position measurement), such as upon power-up of the remote controller 10. The reference value acquisition unit 102 (or the reference value table generation unit 103) calculates a geomagnetic force(s) (geomagnetic force information) that is used as a reference value(s) from the obtained geomagnetic component information.

The reference value table generation unit 103 generates a reference value table that associates geomagnetic forces (geomagnetic force information pieces) obtained/calculated by the reference value acquisition unit 102 with reference positions at which the geomagnetic forces were measured. The reference value table generation unit 103 stores the generated reference value table into the data storage unit 15.

The current value acquisition unit 104 obtains geomagnetic component information that is the current value that is measured when a movement amount is measured (i.e., currently-measured measurement value) from the geomagnetism measurement unit 13. The current value acquisition unit 104 (or the position calculation unit 105) calculates the current geomagnetic force (geomagnetic force information) from the obtained geomagnetic component information.

The position calculation unit 105 calculates the current position of the remote controller 10 based on the current geomagnetic force (geomagnetic force information) obtained/calculated by the current value acquisition unit 104. In this embodiment, the position calculation unit 105 refers to the reference value table in which reference values of the geomagnetic force are associated with reference positions, selects a position corresponding to a reference value that coincides with the current geomagnetic force or a reference value that is closest to the current geomagnetic force as the current position information, and thereby specifies the position of the remote controller 10. It is possible to carry out accurate measurement by specifying the position based on the reference value that coincides with the current value. By specifying the position by using the closest reference value, it is possible to measure the position even in a place between reference values.

The movement amount calculation unit 106 calculates the movement amount (movement amount information) of the remote controller 10 based on the present (current) position information of the remote controller 10 calculated by the position calculation unit 105. The movement amount calculation unit 106 calculates the movement amount of the remote controller 10 based on a difference between the previous position information stored in the data storage unit 15 and the current position information.

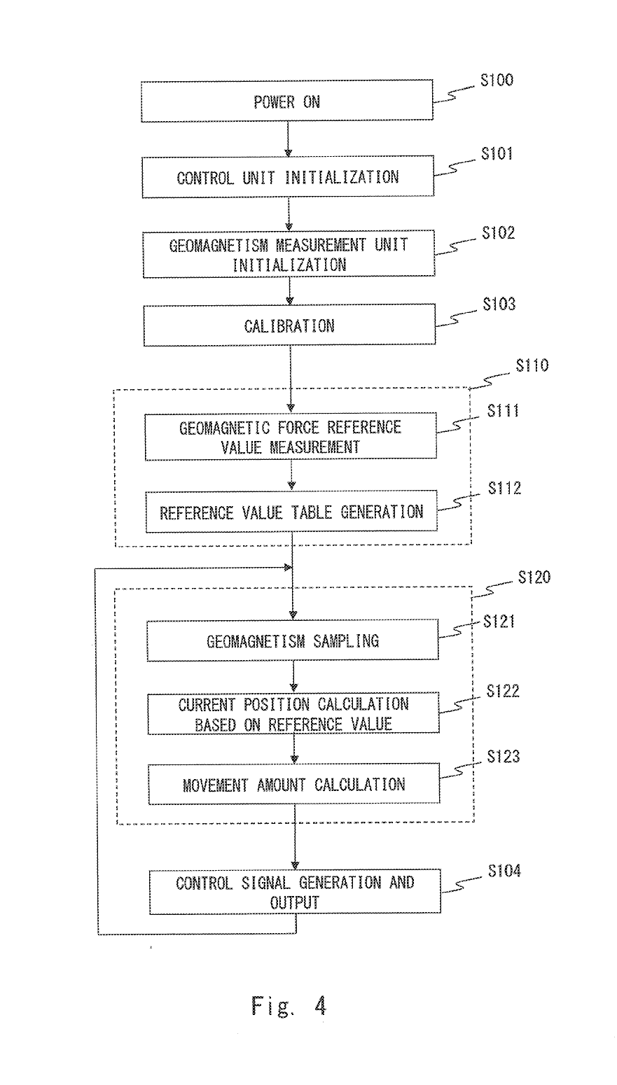

Next, an operation in which a movement amount is measured in the TV game system 100 according to this embodiment is explained. FIG. 4 is a flowchart showing an operation for measuring a movement amount performed mainly by the remote controller 10 shown in FIGS. 2 and 3.

As shown in FIG. 4, firstly, a user powers up the TV game system 100 (step S100). The user powers up the remote controller 10, the game machine main body 20, and the output device 30 in order to play a video game in the TV game system 100. As a result, the remote controller 10, the game machine main body 20, and the output device 30 start processing such as initialization. In each of the steps shown below, an operation of the remote controller 10 is explained.

Next, the remote controller 10 performs the initialization of the control unit 12 (step S101) and the initialization of the geomagnetism measurement unit 13 (step S102). For example, the initialization process is executed for the control unit 12 and the geomagnetism measurement unit 13 by the initializing unit 101. The initialization processes in the steps S101 and S102 are performed so as to make appropriate operation setting (operation clock setting, measurement accuracy setting, or the like) according to the TV game system including the remote controller 10 and the game machine main body 20 based on the specifications of the control unit 12 and the geomagnetism measurement unit 13. These processes are automatically executed by the programming after the step S100.

Next, the remote controller 10 makes an adjustment for the distortion/offset in geomagnetic component measurement result caused by the measurement environment in the geomagnetism measurement unit 13 (i.e., performs calibration) (step S103). For example, a calibration process is performed for the geomagnetism measurement unit 13 by the initializing unit 101. The geomagnetic force that the geomagnetism measurement unit 13 measures is very weak and is susceptible to a magnetic substance(s) present near the geomagnetism measurement unit 13. Therefore, the calibration (S103) is performed in order to check whether or not any distortion/offset occurs in the measured geomagnetic component and, if any distortion/offset occurs, to make an adjustment. This process is performed by an adjustment technique in conformity with the specifications of the geomagnetic sensor included in the geomagnetism measurement unit 13.

Next, the remote controller 10 performs a reference value measurement process (step S110). For example, a reference value measurement process for measuring a position and a movement amount is performed by the reference value acquisition unit 102 and the reference value table generation unit 103. In the reference value measurement process, a geomagnetic force that is used as a reference value in a movement range (along a movement axis) is measured in that movement range (i.e., geomagnetic force reference value is measured). This movement range is defined by moving the remote controller 10 held by a hand in a lateral direction (left/right direction, horizontal direction).

It is assumed that the movement range is defined as a range along one horizontal axis (one straight line). By defining the movement range along a straight line in the horizontal direction, it is possible to perform reliable measurement by using a reference value table, a curved-line expression, an approximate expression, or the like (which are described later).

For example, the reference value measurement range is such a range that a user moves therein when he/she plays a video game in a room. When the geomagnetism fluctuates widely within the reference value measurement range, it is very difficult to measure a position based on a reference value(s). Therefore, the reference value measurement range is such a range that a position can be measured therein by using a reference value table, a curved-line expression, an approximate expression, or the like as described later.

Further, the geomagnetism changes over time. Therefore, it is possible to reduce the errors in the measurement of positions and movement amounts by measuring reference values again after a predetermined time has elapsed after the previous reference value measurement, or by measuring reference values at regular intervals. Further, the geomagnetism also changes according to the place. Therefore, when the range in which the user uses the remote controller is changed, the reference values are measured again. For example, when the position cannot be measured by using a reference value table, a curved-line expression, an approximate expression, or the like (which are described later), there is a possibility that the geomagnetism has fluctuated widely. Therefore, the reference values are preferably measured again.

In this embodiment, as the reference value measurement process (step S110), the measurement of a reference value(s) of a geomagnetic force(s) (step S111) and the generation of a reference value table (step S112) are performed. In the reference value measurement process (step S111), a geomagnetic force(s) is measured in the movement range (movement axis) of the remote controller 10 that a user holds with his/her hand. For example, a range in which a reference value(s) is to be measured and/or a measurement point(s) are displayed on the screen by a game application in the TV game system. Then, a user operates the remote controller 10 according to instructions displayed on the screen so that a reference value(s) is measured. Note that the reference value measurement process may be performed a plurality of times so that a good value(s) or an average value(s) is used as the reference value(s).

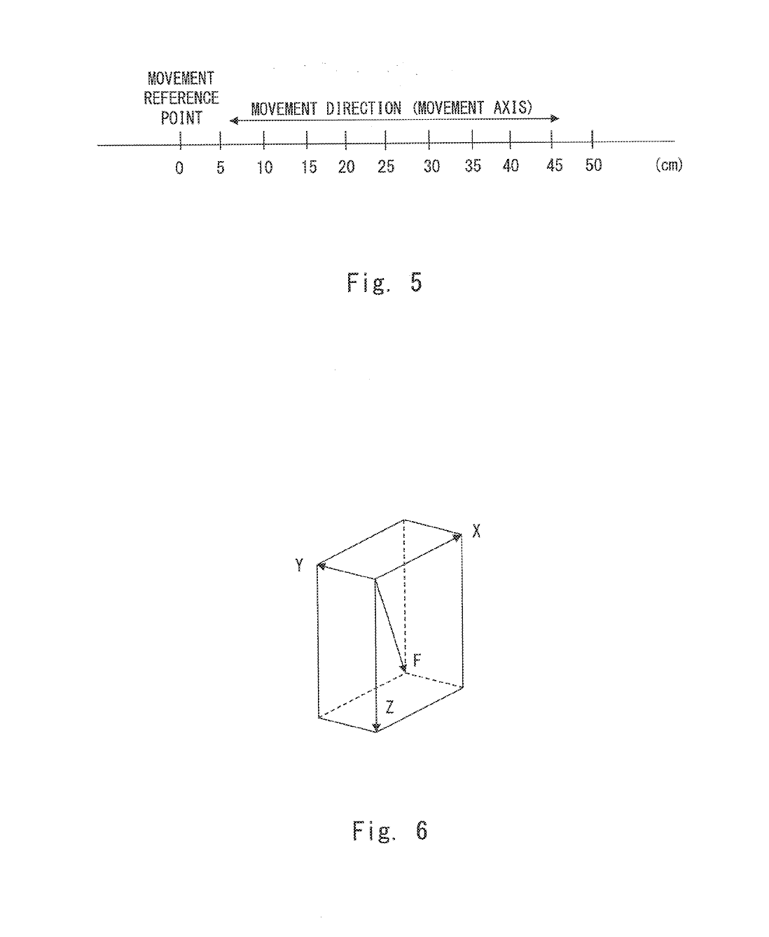

Detailed processes in an example in which a triaxial geomagnetic sensor is used for the geomagnetism measurement unit 13 of the remote controller 10 are explained hereinafter. FIG. 5 shows an example in which a 0 cm point is defined as the movement reference point and a range from 0 cm to 50 cm is defined as the reference value measurement range. Geomagnetic force measurement points are defined at intervals of 5 cm as reference value measurement points. Then, a geomagnetic force used as a reference value is measured at each measurement point. A user moves the remote controller 10 to each measurement point, e.g., to 0 cm, 5 cm, 10 cm, . . . , 50 cm, and so on. The user operates the operation unit 11 (operation button or the like) at each measurement point to instruct the control unit 12 to start measurement so that a geomagnetic force is measured at each measurement point. Alternatively, a user holds the remote controller 10 with his/her hand and moves the remote controller 10 between 0 cm and 50 cm on the movement axis at a fixed speed while the time is measured by the control unit 12, so that a geomagnetic force is measured at regular intervals.

The reference value measurement interval is determined according to the measurement accuracy of the movement amount. Therefore, the reference value measurement interval is, for example, a 10 cm interval or a 5 cm interval. If higher accuracy is desired, the reference value measurement may be performed at a narrower measurement interval. As the measurement interval is narrowed and the number of measurement points is thereby increased, the measurement accuracy improves. However, the amount of reference value data increases. Therefore, when higher accuracy is desired, the measurement interval is preferably narrowed and the number of measurement points is thereby increased. On the other hand, when the amount of data needs to be reduced, the measurement interval is preferably widened and the number of measurement points is thereby reduced.

By measuring a geomagnetic force(s) by using a triaxial geomagnetic sensor for the geomagnetism measurement unit 13, geomagnetic components X, Y and Z like the ones shown in FIG. 6 are output from the geomagnetism measurement unit 13 as a measurement result. The control unit 12 (reference value acquisition unit 102) receives the measurement result (geomagnetic component information) and stores the result into the data storage unit 15. Further, the calculation unit 14 calculates a geomagnetic force F (geomagnetic force information) shown in FIG. 6 by using Expression 1 shown below.

Geomagnetic force (F)=(X²+Y²+Z²)^{1/2} (Expression 1)

After the reference value measurement, the remote controller 10 generates a reference value table (step S112). The control unit 12 (reference value table generation unit 103) stores the calculation result (geomagnetic force information) obtained from the calculation unit 14 into the data storage unit 15, and also stores measurement point information in the measurement into the data storage unit 15 as reference value measurement position information. The reference value table generation unit 103 generates a reference value table that associates a plurality of measurement points (reference position information pieces) with a plurality of geomagnetic force information pieces at respective measurement points, and stores the generated reference value table into the data storage unit 15.

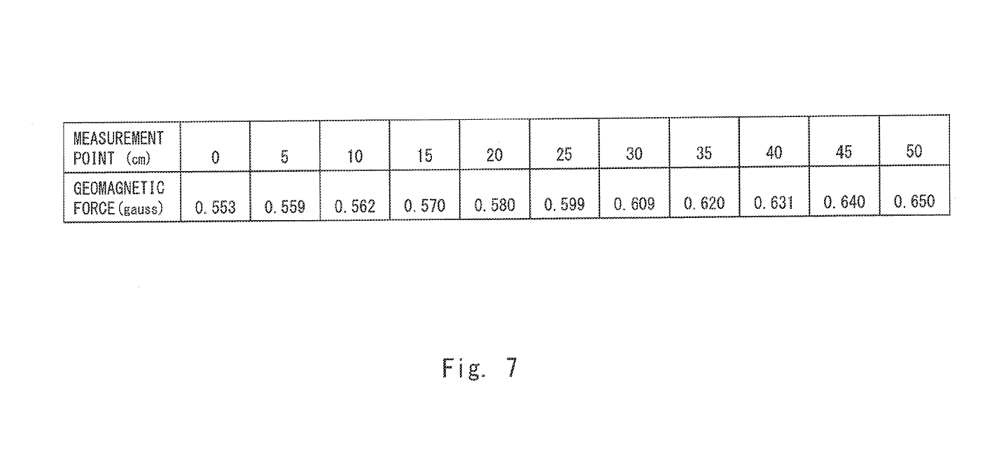

FIG. 7 shows a reference value measurement result (reference value table data) in the movement range of 0 to 50 cm shown in FIG. 5. As shown in FIG. 5, in the movement range of the remote controller 10, an arbitrary point is defined as the measurement reference point (movement reference point) and set as a measurement point 0 cm. From this reference point, the right direction is defined as a movement direction. Further, geomagnetic force measurement points are defined at intervals of 5 cm. The remote controller 10 is disposed at the reference point 0 cm. Then, the control unit 12 obtains a geomagnetic component measurement result (geomagnetic component information) from the geomagnetism measurement unit 13 under the instruction of the operation unit 11 (e.g., when the operation button is pressed down). A geomagnetic force (F) is calculated in the calculation unit 14 by using this measurement result. As a result, a geomagnetic force 0.553 gauss is obtained. The remote controller 10 is moved to the right by 5 cm. Then, a similar operation is performed at the measurement point 5 cm and a geomagnetic force 0.559 gauss is obtained. A geomagnetic force 0.562 gauss is obtained at a position where the remote controller 10 is located after another movement of 5 cm (measurement point 10 cm). Further, a geomagnetic force 0.650 gauss is obtained at the measurement point 50 cm.

As shown in FIG. 7, in the reference value table, measurement points (reference position information pieces) are associated with geomagnetic forces (geomagnetic force information pieces) at respective measurement points. For example, in the reference value table, as the above-described measurement result, a geomagnetic force 0.553 gauss is recorded in a field corresponding to the measurement point 0 cm; a geomagnetic force 0.559 gauss is recorded in a field corresponding to the measurement point 5 cm; a geomagnetic force 0.562 gauss is recorded in a field corresponding to the measurement point 10 cm; and a geomagnetic force 0.650 gauss is recorded in a field corresponding to the measurement point 50 cm.

Next, subsequent to the reference value measurement process (step S110), a position and movement amount measurement process according to the movement of the remote controller 10 that the user holds with his/her hand is performed (step S120). In this embodiment, as the position and movement amount measurement process, geomagnetism sampling in which a geomagnetic force at a position where the remote controller 10 is located is measured is performed. Then, a position and a movement amount are calculated by using its sampling result and the reference values measured in the step S110. Note that in order to calculate a position and a movement amount with high accuracy, the position of the current measurement is preferably located within the measurement range of the reference values.

That is, the remote controller 10 measures a geomagnetic force at a place where the remote controller 10 held by user's hand is located (step S121). Similarly to the step S111, for the geomagnetic force measurement, a user operates the operation unit 11 (operation button or the like) of the remote controller to instruct the control unit 12 to start the measurement. Then, the control unit 12 (current value acquisition unit 104) obtains a geomagnetic component measurement result (geomagnetic component information) obtained by the geomagnetism measurement unit 13. Alternatively, the control unit 12 measures the time and thereby obtains a geomagnetic component measurement result obtained by the geomagnetism measurement unit 13 at regular intervals.

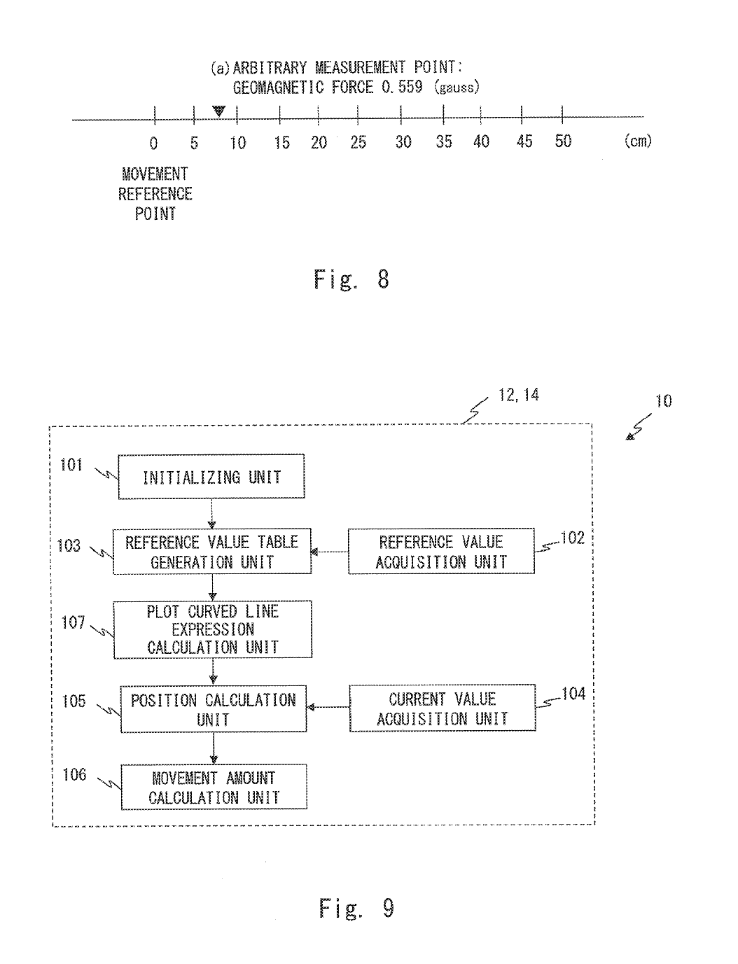

A geomagnetic force is calculated by using this measurement result (geomagnetic component information) in the calculation unit 14 (current value acquisition unit 104). For example, when the remote controller 10 is moved on the movement axis shown in FIG. 5 and thereby located at an arbitrary measurement point as shown in part (a) of FIG. 8, the geomagnetism measurement unit 13 measures geomagnetic components X, Y and Z shown in FIG. 6. Further, a geomagnetic force at that measurement point is calculated in the calculation unit 14 and a geomagnetic force calculation result 0.559 gauss (geomagnetic force information) is stored into the data storage unit 15.

After the sampling of a geomagnetic force, the remote controller 10 calculates the position of the remote controller 10 based on the reference values (reference value table) (step S122). Based on the geomagnetic force at the measurement point where the remote controller 10 is located, which is measured and stored into the data storage unit 15 in the step S121, and the reference value table, which is stored into the data storage unit 15 in the step S112, position information of that measurement point is calculated in the calculation unit 14 (position calculation unit 105) and the calculated position information is stored into the data storage unit 15.

For example, position information (Y) indicating that a geomagnetic force (X) at the measurement point is 0.559 gauss as shown in part (a) of FIG. 8 is compared with geomagnetic forces in the reference value table shown in FIG. 7, and a geomagnetic force closest to this value is searched for. Then, a measurement point corresponding to that geomagnetic force is defined as the position information of the remote controller 10 and stored into the data storage unit 15. As shown in FIG. 7, a geomagnetic force 0.559 gauss is registered in the reference value table. Therefore, the measurement point 5 cm corresponding to the geomagnetic force 0.559 gauss is selected as the position information. Further, when the measured geomagnetic force is 0.560 gauss, the registered geomagnetic force 0.559 gauss is closest to the measured geomagnetic force. Therefore, the measurement point 5 cm corresponding to the geomagnetic force 0.559 gauss is selected as the position information. That is, as a result of comparison between the geomagnetic force 0.559 gauss at the place where the remote controller 10 is located and data in the reference value table, it can be derived that the remote controller 10 is located at a position that is about 5 cm away from the movement reference point shown in FIG. 5 (relative position with respect to the reference point).

After the calculation of the position information, the remote controller 10 calculates a movement amount based on the calculated position information (step S123). Since the steps S121 and S122 are repeatedly performed, a plurality of position information pieces are stored in the data storage unit 15. A movement amount is calculated in the calculation unit 14 (movement amount calculation unit 106) based on the current position information, which is calculated and stored into the data storage unit 15 in the step S122, and the previous position information stored in the data storage unit 15. Further, the calculated movement amount is stored into the data storage unit 15.

Assuming that the position information at the previous measurement point stored in the data storage unit 15 is, for example, a place that is 10 cm away from the movement reference point, the movement amount is calculated in the calculation unit 14 based on the position information in the previous measurement and the position information in the current measurement by using Expression 2 shown below.

Movement amount=Current position information−Previous position information=5.0 cm−10.0 cm=−5.0 cm (Expression 2)

As a result, it can be derived that the remote controller is located at a position that is 5.0 cm to the left from the previous position. These calculation results (Position information 5.0 cm and Movement amount information −5.0 cm) are stored into the data storage unit 15.

Next, in order to control the TV game system by using the result obtained in the step S123, the position information and the movement amount measurement result (movement amount information) are output from the output unit 16 of the remote controller 10 to the input unit 22 of the game machine main body 20 as a control signal(s) (step S104). For the output of the control signal, it is possible to instruct the control unit 12 or the output unit to start the output by operating the operation unit 11 of the operation unit 11. Alternatively, the control unit 12 of the remote controller 10 measures the time and the control signal is output at regular intervals.

After the output, the step S120 (S121 to S123) is performed in order to continue the position calculation and the movement amount calculation. Then, the step S104 for outputting the calculation result is performed. These processes are repeatedly performed unit the power is turned off.

As described above, in this embodiment, reference geomagnetic forces at a plurality of reference positions are generated and stored as a reference value table in advance. Then, a geomagnetic force at a measurement position is compared with the reference value table and a position corresponding to a geomagnetic force closest to the value at the measurement position is determined as the current position. In this way, it is possible to measure the position of an object with high accuracy. Since the geomagnetism is a magnetic field of Earth, its strength (geomagnetic force) changes according to the measurement position. However, in this embodiment, since a reference value table is generated in advance, it is possible to accurately measure a position. Further, a movement amount can be also reliably measured by calculating the movement amount based on measured position information.

Further, by measuring a position and a movement amount by using the geomagnetism, it is possible to measure the position and the movement amount even when a obstacle and/or a shielding object is present between the game machine main body 20 and the remote controller 10.

When the above-described prior art is compared with this embodiment, Japanese Unexamined Patent Application Publication No. 2009-156779 cannot detect the position because the movement is detected based on difference information of the geomagnetism, whereas this embodiment can detect the position based on geomagnetic forces at a plurality of reference positions and a current geomagnetic force.

In Published Japanese Translation of PCT International Publication for Patent Application, No. 2001-500299, the input device detects the direction of a magnetic field from magnetic components (x, y, z). Further, a translational motion of a graphical element on the display is controlled according to the change in the direction of the magnetic field. In Published Japanese Translation of PCT International Publication for Patent Application, No. 2001-500299, magnetic components at one reference position are used as a reference value(s) and the graphical element is moved according to the current magnetic components. However, the graphical element is not controlled according to the actual position and the movement amount of the input device.

### Second Embodiment

A second embodiment is explained hereinafter with reference to the drawings. In this embodiment, a position is detected based on a plotted-curved-line expression (polygonal-line expression) that connects each measurement point in a reference value table. Note that the overall configuration of a system according to this embodiment is similar to that according to first embodiment shown in FIG. 2.

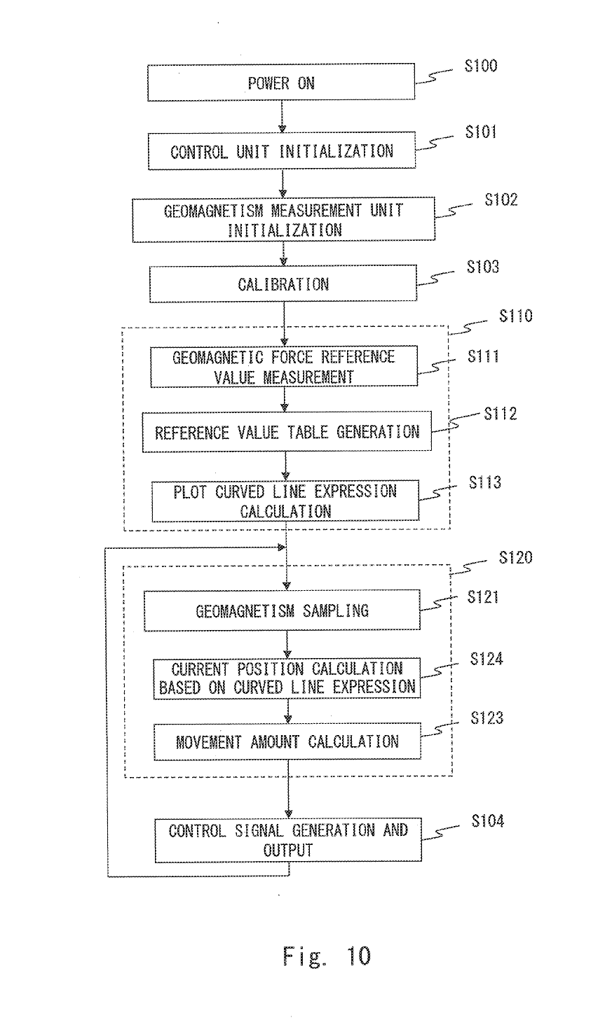

FIG. 9 is a functional block diagram of the remote controller 10 according to this embodiment, and shows a configuration example of blocks for performing mainly movement amount measurement (position measurement) in the control unit 12 and the calculation unit 14. Note that the functional block diagram shown in FIG. 9 is a mere example. That is, other block configuration may be also used, provided that the movement amount measurement operation (position measurement operation) according to this embodiment can be implemented.

As shown in FIG. 9, the remote controller 10 according to this embodiment includes, similarly to that shown in FIG. 3, a remote controller 10, a reference value acquisition unit 102, a reference value table generation unit 103, a current value acquisition unit 104, a position calculation unit 105, and a movement amount calculation unit 106. Further, in this embodiment, the remote controller 10 also includes a plotted-curved-line expression calculation unit 107.

The plotted-curved-line expression calculation unit 107 plots reference values (geomagnetic forces, measurement points) of the reference value table generated by the reference value table generation unit 103 and calculates a plotted-curved-line expression that connects each point (X, Y). The plotted-curved-line expression calculation unit 107 connects each point (i.e., each two consecutive points) with a straight line and calculates a plurality of expressions each of which corresponds to a respective one of a plurality of straight lines (polygonal line). The plotted-curved-line expression is a polygonal-shaped curved-line expression that associates a plurality of reference positions with a plurality of reference geomagnetism information pieces registered in the reference value table.

The position calculation unit 105 calculates the current position of the remote controller 10 based on the current geomagnetic force obtained/calculated by the current value acquisition unit 104. In this embodiment, the position calculation unit 105 determines the current position of the remote controller 10 by inputting (substituting) the current geomagnetic force into the plotted-curved-line expression calculated by the plotted-curved-line expression calculation unit 107 and performing calculation using the plotted-curved-line expression.

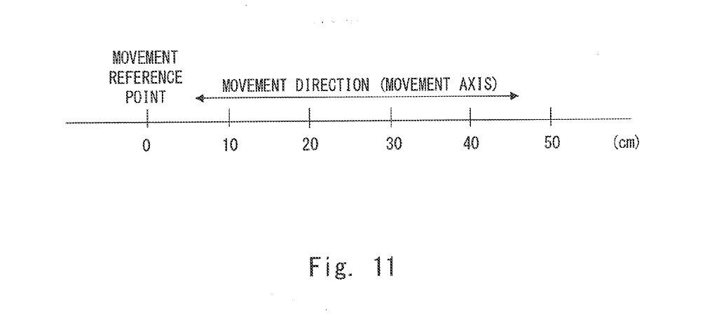

Next, an operation in which a movement amount is measured in the TV game system 100 according to this embodiment is explained. FIG. 10 is a flowchart showing an operation for measuring a movement amount performed mainly by the remote controller 10 shown in FIGS. 2 and 9.

As shown in FIG. 10 and similarly to FIG. 4, a user powers up the TV game system 100 (step S100). The remote controller 10 performs the initialization of the control unit 12 and the initialization of the geomagnetism measurement unit 13 (steps S101 and S102). Further, the remote controller 10 performs calibration for the geomagnetism measurement unit 13 (step S103).

Next, the remote controller 10 performs a reference value measurement process (step S110). In this embodiment, as the reference value measurement process (step S110), the measurement of a reference value(s) of a geomagnetic force(s) (step S111), the generation of a reference value table (step S112), and the calculation of a plotted-curved-line expression are performed. In the reference value measurement process (step S111), a geomagnetic force is measured in the movement range (movement axis) of the remote controller 10 that a user holds with his/her hand.

FIG. 11 shows an example in which a 0 cm point is defined as the movement reference point and a range from 0 cm to 50 cm is defined as the reference value measurement range. Geomagnetic force measurement points are defined at intervals of 10 cm as reference value measurement points. Then, a geomagnetic force used as a reference value is measured at each measurement point. A user moves the remote controller 10 to each measurement point, e.g., to 0 cm, 10 cm, 20 cm, . . . , 50 cm, and so on. The user operates the operation unit 11 (operation button or the like) at each measurement point to instruct the control unit 12 to start measurement so that a geomagnetic force is measured at each measurement point. Alternatively, a user holds the remote controller 10 with his/her hand and moves the remote controller 10 between 0 cm to 50 cm on the movement axis at a fixed speed while the time is measured by the control unit 12, so that the geomagnetic force is measured at regular intervals.

For example, while a reference value is measured at intervals of 5 cm in the first embodiment, a reference value is measured at intervals of 10 cm in this embodiment. In the first embodiment, it is necessary to measure reference values at a narrow interval in order to achieve accurate measurement. In this embodiment, a geomagnetic force(s) and a position(s) in between each reference value (i.e., between each two consecutive reference values) in the reference value table can be estimated by using the curved-line expression. Therefore, it is possible to widen the measurement interval between reference values in comparison to the first embodiment.

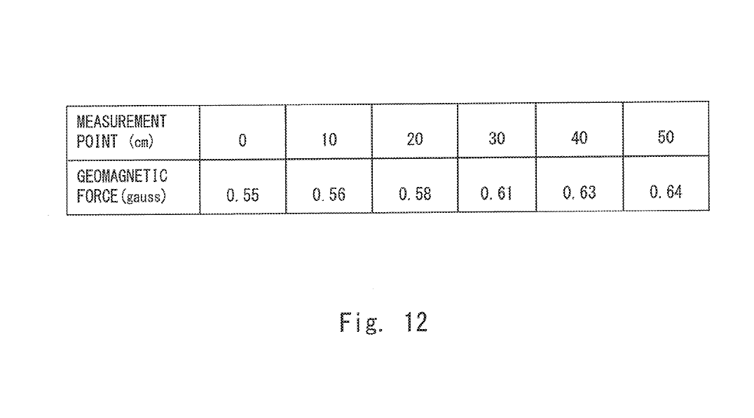

After the reference value measurement, the remote controller 10 generates a reference value table (step S112). FIG. 12 shows an example of a reference value table according to this embodiment. As shown in FIG. 12, measurement points are associated with geomagnetic forces at the measurement points in the reference value table. For example, in the reference value table, as the above-described measurement result, a geomagnetic force 0.55 gauss is recorded in a field corresponding to the measurement point 0 cm; a geomagnetic force 0.56 gauss is recorded in a field corresponding to the measurement point 10 cm; a geomagnetic force 0.58 gauss is recorded in a field corresponding to the measurement point 20 cm; . . . ; and a geomagnetic force 0.64 gauss is recorded in a field corresponding to the measurement point 50 cm.

After the generation of the reference value table, the remote controller 10 calculates a plotted-curved-line expression (step S113). The plotted-curved-line expression calculation unit 107 plots reference values registered in the reference value table generated in the step S112 and connects each point. As shown in FIG. 13, measurement values in the reference value table shown in FIG. 12 are plotted as P1 to P6 on an X-Y coordinate system. Each two consecutive points of the points P1 to P6 are connected by a straight line, and an expression corresponding to each straight line is calculated. An expression S1 connecting points P1 and P2, an expression S2 connecting points P2 and P3, an expression S3 connecting points P3 and P4, an expression S4 connecting points P4 and P5, and an expression S5 connecting points P5 and P6 are calculated. For example, the expression S1 is calculated as a linear expression connecting P1(0.55, 0) and P2(0.56, 10); the expression S2 is calculated as a linear expression connecting P2(0.56, 10) and P3(0.58, 20); . . . ; and the expression S5 is calculated as a linear expression connecting P5(0.63, 40) and P6(0.64, 50). The calculated expressions S1 to S5 (expression information) are stored into the data storage unit 15.

Next, subsequent to the reference value measurement process (step S110), a movement amount measurement process according to the movement of the remote controller 10 held by user's hand is performed (step S120). In this embodiment, as the movement amount measurement process, geomagnetism sampling in which a geomagnetic force at a position where the remote controller 10 is located is measured is performed. Then, a position and a movement amount are calculated by using its sampling result and the plotted-curved-line expression calculated in the step S110.

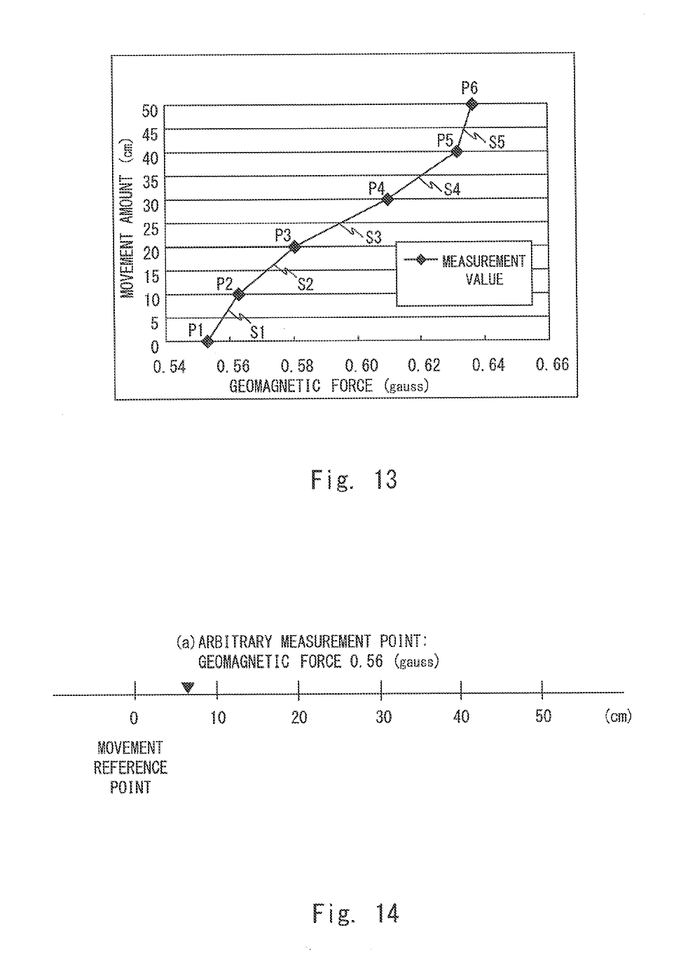

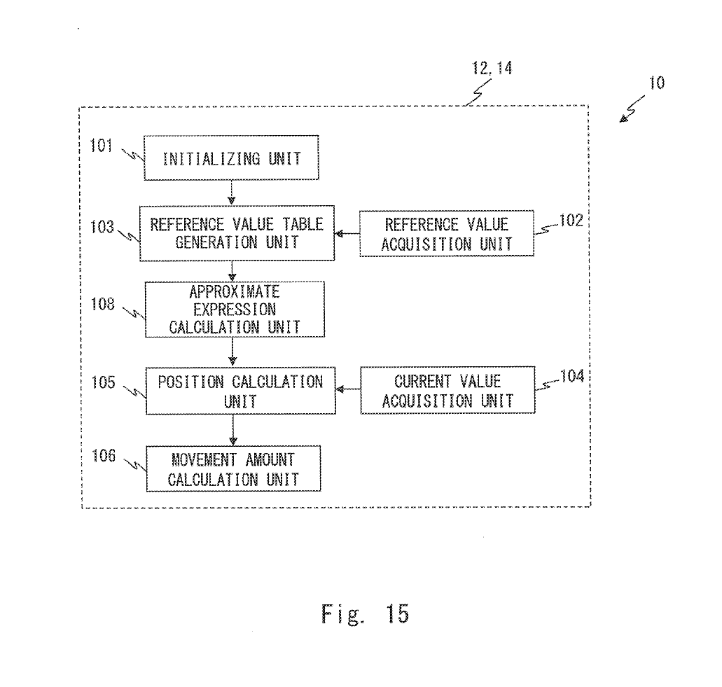

That is, the remote controller 10 measures a geomagnetic force at a place where the remote controller 10 held by user's hand is located (step S121). For example, when the remote controller 10 is moved on the movement axis shown in FIG. 11 and thereby located at an arbitrary measurement point shown in part (a) of FIG. 14, the geomagnetism measurement unit 13 measures geomagnetic components X, Y and Z. Further, a geomagnetic force at that measurement point is calculated in the calculation unit 14 and a geomagnetic force calculation result 0.56 gauss (geomagnetic force information) is stored into the data storage unit 15.

After the sampling of a geomagnetic force, the remote controller 10 calculates the position of the remote controller 10 based on the plotted-curved-line expression (step S124). Based on the geomagnetic force at the place where the remote controller 10 is located, which is measured and stored into the data storage unit 15 in the step S121, and the plotted-curved-line expression, which is stored into the data storage unit 15 in the step S113, position information of that measurement point is calculated in the calculation unit 14 (position calculation unit 105) and the calculated position information is stored into the data storage unit 15. The position is determined by determining which expression can be applied among the expressions included in the plotted-curved-line expression according to the geomagnetic force at the measurement point based on the reference value geomagnetic force.

For example, when a geomagnetic force (X) at the measurement point is 0.56 gauss as shown in part (a) of FIG. 14, the value 0.56 gauss is substituted into the plotted-curved-line expression. In the example shown in FIGS. 12 and 13, when the value is between 0.55 gauss and 0.56 gauss, the expression S1 is used. Further, when the value is between 0.56 gauss and 0.58 gauss, the expression S2 is used. In part (a) of FIG. 14, since the value is 0.56 gauss, it is substituted into the expression S1 or S2. As a result, the position corresponding to 0.56 gauss is calculated to be 10 cm. Therefore, it can be derived that the arbitral measurement point (▾ point) shown in part (a) of FIG. 14 is a position that is about 10 cm away from the movement reference point (0 cm).

After the calculation of the position information, the remote controller 10 calculates a movement amount based on the calculated position information. Next, in order to control the TV game system by using the result obtained in the step S123, the position information and the movement amount measurement result are output from the output unit 16 of the remote controller 10 to the input unit 22 of the game machine main body 20 as a control signal(s) (step S104).

As described above, in this embodiment, a plotted-curved-line expression that connects reference values (points) registered in the reference value table is calculated. Then, the current position is determined by substituting a measured geomagnetic force into this plotted-curved-line expression. In this way, it is possible to estimate a geomagnetic force between each measurement point (i.e., between each two consecutive measurement points), and thus making it possible to measure the position of an abject with high accuracy. By preparing a plurality of expressions, it is possible to determine a position with high accuracy. Further, a movement amount can be also reliably measured by calculating the movement amount based on measured position information.

Further, since the plotted-curved-line expression is used, the accuracy does not deteriorate even when the measurement interval between reference values is increased in comparison to the first embodiment. Therefore, it is possible to reduce the table size of the reference value table. Accordingly, it is possible to reduce the circuit size and so on.

### Third Embodiment

A third embodiment is explained hereinafter with reference to the drawings. In this embodiment, a position is detected based on an approximate expression that approximates each measurement point in a reference value table. Note that the overall configuration of a system according to this embodiment is similar to that according to first embodiment shown in FIG. 2.

FIG. 15 is a functional block diagram of the remote controller 10 according to this embodiment, and shows a configuration example of blocks for performing mainly movement amount measurement (position measurement) in the control unit 12 and the calculation unit 14. Note that the functional block diagram shown in FIG. 15 is a mere example. That is, other block configuration may be also used, provided that the movement amount measurement operation (position measurement operation) according to this embodiment can be implemented.

As shown in FIG. 15, the remote controller 10 according to this embodiment includes, similarly to that shown in FIG. 3, a remote controller 10, a reference value acquisition unit 102, a reference value table generation unit 103, a current value acquisition unit 104, a position calculation unit 105, and a movement amount calculation unit 106. Further, in this embodiment, the remote controller 10 also includes an approximate expression calculation unit 108.

The approximate expression calculation unit 108 plots reference values (geomagnetic forces, measurement points) of the reference value table generated by the reference value table generation unit 103 and calculates an approximate expression that approximates each point (X, Y). The approximate expression is an expression that approximates a relation between a plurality of reference positions and a plurality of reference geomagnetism information pieces registered in the reference value table.

The position calculation unit 105 calculates the current position of the remote controller 10 based on the current geomagnetic force obtained/calculated by the reference value acquisition unit 102. In this embodiment, the position calculation unit 105 determines the current position of the remote controller 10 by inputting (substituting) the current geomagnetic force into the approximate expression calculated by an approximate expression calculation unit 108 and performing calculation using the approximate expression.

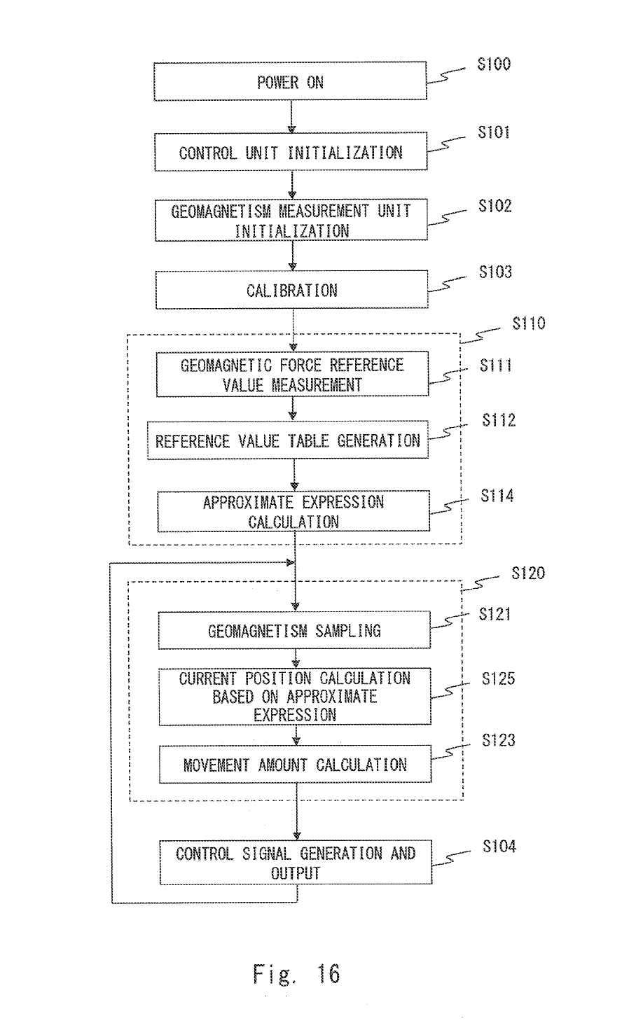

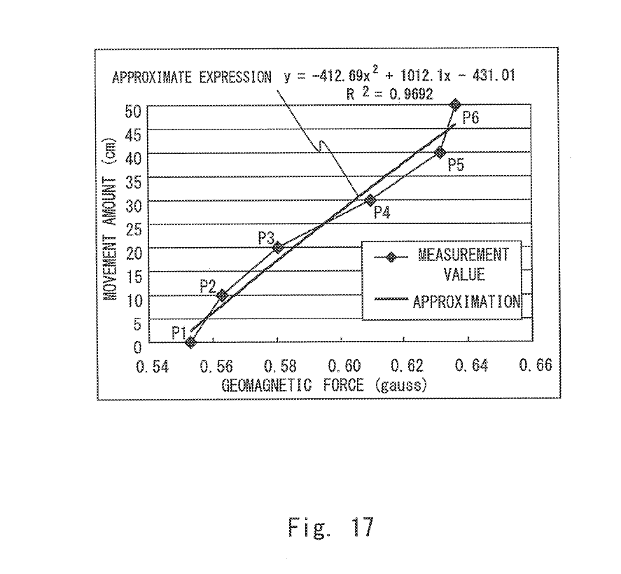

Next, an operation in which a movement amount is measured in the TV game system 100 according to this embodiment is explained. FIG. 16 is a flowchart showing an operation for measuring a movement amount performed mainly by the remote controller 10 shown in FIGS. 2 and 15.

As shown in FIG. 16 and similarly to FIG. 4, a user powers up the TV game system 100 (step S100). The remote controller 10 performs the initialization of the control unit 12 and the initialization of the geomagnetism measurement unit 13 (steps S101 and S102). Further, the remote controller 10 performs calibration for the geomagnetism measurement unit 13 (step S103).

Next, the remote controller 10 performs a reference value measurement process (step S110). In this embodiment, as the reference value measurement process (step S110), the measurement of a reference value(s) of a geomagnetic force(s) (step S111), the generation of a reference value table (step S112), and the calculation of an approximate expression are performed.

In the reference value measurement process (step S111), a geomagnetic force is measured in the movement range (movement axis) of the remote controller 10 that a user holds with his/her hand. For example, similarly to the second embodiment, a range from 0 cm to 50 cm is defined as the reference value measurement range and a geomagnetic force is measured at intervals of 10 cm as shown in FIG. 11. In this embodiment, similarly to the second embodiment, a geomagnetic force(s) and a position(s) in between each reference value (i.e., between each two consecutive reference values) in the reference value table can be estimated. Therefore, it is possible to widen the measurement interval between reference values in comparison to the first embodiment.

After the reference value measurement, the remote controller 10 generates a reference value table (step S112). For example, similarly to the second embodiment, geomagnetic forces 0.55 gauss, 0.56 gauss, . . . , and 0.64 gauss are recorded in fields corresponding to the measurement points 0 cm, 10 cm, . . . , and 50 cm respectively.

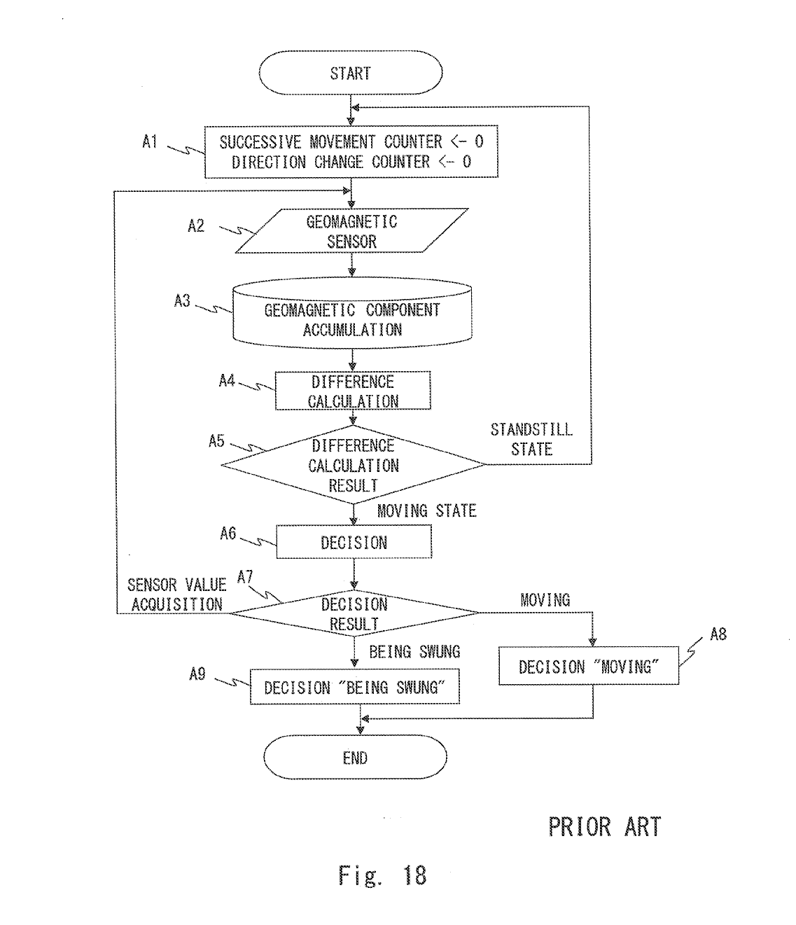

After the generation of the reference value table, the remote controller 10 calculates an approximate expression (step S114). The approximate expression calculation unit 108 plots reference values registered in the reference value table generated in the step S112 and calculates an approximate expression that approximates each point. The approximate expression calculation unit 108 obtains a polynomial equation that serves as the approximate expression by using a least squares method or the like. As shown in FIG. 17, when measurement values in the reference value table shown in FIG. 12 are plotted as P1 to P6 on an X-Y coordinate system, an approximate expression that approximates the points P1 to P6 is obtained. Coefficients of the polynomial equation are obtained from P1(0.55, 0), P2(0.56, 10), . . . , and P6(0.64, 50), and the resultant polynomial equation is used as the approximate expression. In the example shown in FIG. 17, Expression 3 shown below is used as the approximate expression.

y=−412.69x²+1012.1x−431.01 (R²=0.9692) (Expression 3)

The calculated approximate expression (expression information) is stored into the data storage unit 15.

Next, subsequent to the reference value measurement process (step S110), a movement amount measurement process according to the movement of the remote controller 10 held by user's hand is performed (step S120). In this embodiment, as the movement amount measurement process, geomagnetism sampling in which a geomagnetic force at a position where the remote controller 10 is located is measured is performed. Then, a position and a movement amount are calculated by using its sampling result and the approximate expression calculated in the step S110.

That is, the remote controller 10 measures a geomagnetic force at a place where the remote controller 10 held by user's hand is located (step S121). For example, when the remote controller 10 is moved on the movement axis shown in FIG. 11 and thereby located at an arbitrary measurement point shown in part (a) of FIG. 14, the geomagnetism measurement unit 13 measures geomagnetic components X, Y and Z. Further, a geomagnetic force at that measurement point is calculated in the calculation unit 14 and a geomagnetic force calculation result 0.56 gauss (geomagnetic force information) is stored into the data storage unit 15.

After the sampling of a geomagnetic force, the remote controller 10 calculates the position of the remote controller 10 based on the approximate expression (step S125). Based on the geomagnetic force at the place where the remote controller 10 is located, which is measured and stored into the data storage unit 15 in the step S121, and the approximate expression, which is stored into the data storage unit 15 in the step S114, position information of that measurement point is calculated in the calculation unit 14 (position calculation unit 105) and the calculated position information is stored into the data storage unit 15.

For example, when a geomagnetic force (X) at the measurement point is 0.56 gauss as shown in part (a) of FIG. 14, the value 0.56 gauss is substituted into the approximate expression, i.e., into the above-described Expression 3. As a result, position information (Y) is calculated as shown as Expression 4 shown below.

Position information Y=−412.69X²+1012.1X−431.01=6.35 cm (Expression 4)

From the result of the above-described Expression 4, it can be derived that the arbitral measurement point (▾ point) shown in part (a) of FIG. 14 is a position that is about 6 cm away from the movement reference point (0 cm).

After the calculation of the position information, the remote controller 10 calculates a movement amount based on the calculated position information. Assuming that the position information at the previous measurement point stored in the data storage unit 15 is, for example, a place that is 10 cm away from the movement reference point, the movement amount is calculated in the calculation unit 14 based on the position information in the previous measurement and the position information in the current measurement by using Expression 2 shown below.

Movement amount=Current position information−Previous position information=6.35 cm−10 cm=−3.65 cm (Expression 5)

As a result, it can be derived that the remote controller is located at a position that is 3.65 cm to the left from the previous position. These calculation results (Position information 6.35 cm and Movement amount information −3.65 cm) are stored into the data storage unit 15.

Next, in order to control the TV game system by using the result obtained in the step S123, the position information and the movement amount measurement result are output from the output unit 16 of the remote controller 10 to the input unit 22 of the game machine main body 20 as a control signal(s) (step S104).

As described above, in this embodiment, an approximate expression that approximates reference values (points) registered in the reference value table is calculated. Then, the current position is determined by substituting a measured geomagnetic force into this approximate expression. In this way, it is possible to estimate a geomagnetic force between each measurement point (i.e., between each two consecutive measurement points), and thus making it possible to measure the position of an abject with high accuracy. A movement amount can be also reliably measured by calculating the movement amount based on measured position information.

Further, since an approximate expression is used, the accuracy does not deteriorate even when the measurement interval between reference values is increased in comparison to the first embodiment as in the case of the second embodiment. Therefore, it is possible to reduce the table size of the reference value table.

Further, while a plurality of straight line expressions that form a curved line need to be obtained and stored in the second embodiment, only one approximate expression needs to be obtained and stored in this embodiment. Therefore, it is possible to reduce the data size of the approximate expression in this embodiment in comparison to the plotted-curved-line expression in the second embodiment. As a result, the amount of data is reduced in comparison to the second embodiment, and thus making it possible to lower the power consumption of the CPU and to reduce the circuit size.

The present invention made by the inventors of the present application has been explained above in a concrete manner based on embodiments. However, the present invention is not limited to the above-described embodiments, and needless to say, various modifications can be made without departing from the spirit and scope of the present invention.

Although the above-described embodiments are explained by using the TV game system 100 shown in FIG. 2, the above-described apparatus and configuration, in particular, the remote controller 10 and the input/output directions of signals may be implemented by using different configurations. For example, the input/output of the control unit 12 and the geomagnetism measurement unit 13 are described in such a manner that the geomagnetism measurement unit 13 outputs a measurement result to the control unit 12. However, the control unit 12 may instruct the geomagnetism measurement unit 13 to start geomagnetic component measurement (make a measurement request).

Further, although the position and movement amount measurement process is performed inside the remote controller in the above-described embodiments, the measurement process may be performed outside the remote controller. For example, a block configuration like the one shown in FIG. 3 may be provided in the control unit of the game machine main body and the position calculation and/or the movement amount calculation may be performed therein. Since the game machine main body is more sophisticated than the remote controller, the game machine main body can process a larger amount of data and perform more complicated calculation at a higher speed.

Further, although reference values are measured in advance in the geomagnetism measurement unit disposed inside the remote controller, which is the object to be measured, in the above-described embodiments, reference values may be measured outside the remote controller. For example, reference values may be measured by disposing geomagnetic sensors at regular intervals. Alternatively, reference values may be measured by using a plurality of remote controllers.

Although examples in which a position and a movement amount are measured by using the geomagnetism in a TV game system are explained in the above-described embodiments, the present invention is not limited to these examples. That is, a position and a movement amount may be measured by using the geomagnetism in other systems.

The first to third embodiments can be combined as desirable by one of ordinary skill in the art.

While the invention has been described in terms of several embodiments, those skilled in the art will recognize that the invention can be practiced with various modifications within the spirit and scope of the appended claims and the invention is not limited to the examples described above.

Further, the scope of the claims is not limited by the embodiments described above.

Furthermore, it is noted that, Applicant's intent is to encompass equivalents of all claim elements, even if amended later during prosecution.

What is claimed is:

1. A position measurement apparatus comprising:
a reference value acquisition unit that obtains a plurality of reference geomagnetism information pieces, the plurality of reference geomagnetism information pieces being geomagnetism information pieces measured at a plurality of reference positions;
an association information generation unit that generates association information that associates the plurality of reference positions with the plurality of reference geomagnetism information pieces;
a measurement value acquisition unit that obtains measurement geomagnetism information, the measurement geomagnetism information being geomagnetism information measured at a measurement position; and
a position specifying unit that specifies a position corresponding to the measurement geomagnetism information based on association between the plurality of reference positions and the plurality of reference geomagnetism information pieces obtained by the association information.

2. The position measurement apparatus according to claim 1, wherein the association information is a reference value table that associates the plurality of reference positions with the plurality of reference geomagnetism information pieces.

3. The position measurement apparatus according to claim 2, wherein the position specifying unit specifies the position by a reference position corresponding to a reference geomagnetism information piece that coincides with the measurement geomagnetism information among the plurality of reference geomagnetism information pieces registered in the reference value table.

4. The position measurement apparatus according to claim 2, wherein the position specifying unit specifies the position by a reference position corresponding to a reference geomagnetism information piece closest to the measurement geomagnetism information among the plurality of reference geomagnetism information pieces registered in the reference value table.

5. The position measurement apparatus according to claim 1, wherein the association information is a curved-line expression that associates the plurality of reference positions with the plurality of reference geomagnetism information pieces.

6. The position measurement apparatus according to claim 5, wherein the position specifying unit specifies the position by substituting the measurement geomagnetism information into the curved-line expression.

7. The position measurement apparatus according to claim 5, wherein the curved-line expression is a polygonal-shaped curved-line expression that associates the plurality of reference positions with the plurality of reference geomagnetism information pieces.

8. The position measurement apparatus according to claim 5, wherein the curved-line expression is an approximate expression that approximates a relation between the plurality of reference positions and the plurality of reference geomagnetism information pieces.

9. The position measurement apparatus according to claim 1, wherein the geomagnetism information is a geomagnetic force based on geomagnetic components on a plurality of axes detected by a geomagnetic sensor.

10. The position measurement apparatus according to claim 1, wherein the measurement position is a position within a measurement range of the plurality of reference positions.

11. The position measurement apparatus according to claim 1, wherein the plurality of reference positions and the measurement position are positions on a first movement axis.

12. The position measurement apparatus according to claim 1, wherein the reference value acquisition unit obtains the plurality of reference geomagnetism information pieces measured at a regular interval.

13. The position measurement apparatus according to claim 1, wherein when the position specifying unit cannot specify the position based on the association information, the reference value acquisition unit obtains the plurality of reference geomagnetism information pieces that are newly measured.

14. The position measurement apparatus according to claim 1, wherein
the position specifying unit repeatedly specifies the position, and
the position measurement apparatus further comprises a movement amount calculation unit that calculates a movement amount based on a difference between the plurality of specified positions.

15. A position measurement method comprising:
obtaining a plurality of reference geomagnetism information pieces, the plurality of reference geomagnetism information pieces being geomagnetism information pieces measured at a plurality of reference positions;
generating association information that associates the plurality of reference positions with the plurality of reference geomagnetism information pieces;
obtaining measurement geomagnetism information, the measurement geomagnetism information being geomagnetism information measured at a measurement position; and
specifying a position corresponding to the measurement geomagnetism information based on association between the plurality of reference positions and the plurality of reference geomagnetism information pieces obtained by the association information.

16. The position measurement method according to claim 15, wherein the association information is a reference value table that associates the plurality of reference positions with the plurality of reference geomagnetism information pieces.

17. The position measurement method according to claim 15, wherein the association information is a curved-line expression that associates the plurality of reference positions with the plurality of reference geomagnetism information pieces.

18. The position measurement method according to claim 17, wherein the curved-line expression is a polygonal-shaped curved-line expression that associates the plurality of reference positions with the plurality of reference geomagnetism information pieces.

19. The position measurement method according to claim 17, wherein the curved-line expression is an approximate expression that approximates a relation between the plurality of reference positions and the plurality of reference geomagnetism information pieces.

20. A non-transitory computer readable medium storing a position measurement program for causing a computer to execute position measurement processing, the position measurement processing comprises:
obtaining a plurality of reference geomagnetism information pieces, the plurality of reference geomagnetism information pieces being geomagnetism information pieces measured at a plurality of reference positions;
generating association information that associates the plurality of reference positions with the plurality of reference geomagnetism information pieces;
obtaining measurement geomagnetism information, the measurement geomagnetism information being geomagnetism information measured at a measurement position; and
specifying a position corresponding to the measurement geomagnetism information based on association between the plurality of reference positions and the plurality of reference geomagnetism information pieces obtained by the association information.
